(19) United States
(12) Patent Application Publication
(10) Pub. No.: US 2011/0112703 A1
(43) Pub. Date: May 12, 2011

(54) POWER MANAGEMENT SYSTEM

(76) Inventors: Eric Lundberg, Reston, VA (US); Michael Draszt, Oak Harbor, WA (US)

(21) Appl. No.: 13/003,448

(22) PCT Filed: Jul. 10, 2009
(86) PCT No.: PCT/US2009/050291

§ 371 Date: Jan. 10, 2011

Related U.S. Application Data
(60) Provisional application No. 61/080,103, filed on Jul. 11, 2008.

(51) Int. Cl. G06F 1/26

(52) U.S. Cl. 700/297

(57) ABSTRACT

Distributed power storage capabilities are provided for electrical-power-providers by placing electrical storage systems at power consumption facilities. Power can be stored in such storage systems when power prices are low and can be released from such storage systems when power prices are high. With or without the electrical storage systems, power from particular power generation sources, such as renewable power generation sources can be identified by a power consumer for usage. In some cases, power from the particular power generation sources is used only when pricing conditions are met.

### CROSS-REFERENCE TO RELATED APPLICATION

This application claims priority from U.S. Provisional Application No. 61/080,103, filed Jul. 11, 2008, the entire disclosure of which is hereby incorporated herein by reference.

### FIELD OF THE INVENTION

The invention relates in general to power management systems. More specifically, the invention relates to power management systems that enable power generated from multiple facilities and multiple generation and/or storage sources to be efficiently managed.

### BACKGROUND

The present electrical-power generation system and distribution grid suffers from the problem that it is costly to adjust power output to meet peak power demand during power consumption cycles. For example, some power generation sources, like nuclear power generation facilities, hydroelectric power generation facilities and coal power generation facilities, operate most efficiently when operating continuously at their individual maximum capacity. Accordingly, nuclear, hydroelectric and coal power generation facilities are often used by electric utility companies to meet base demand requirements, as they can continuously generate large amounts of power relatively inexpensively when compared with other types of power generation sources. These types of generation facilities, however, cannot be brought online quickly and easily to meet spikes in demand, commonly referred to as “peak demand periods”, from the base demand requirements. Accordingly, utility companies are required to build “peaking plants,” such as oil-fired and gas-fired generation facilities, that can be easily and quickly brought online to meet energy requirements during peak demand periods. The marginal cost of operating the peaking plants is relatively high, however, as a large capital investment is required to build peaking plants but their capacity is only utilized during the peak demand periods. Alternatively, the utility companies could increase the capacity of their base demand generation facilities to a level equal to anticipated peak demand, but this would result in the base demand generation facilities continuously producing at a power level that is only required during the peak demand periods. In fact, situations already exist in which demand falls below the anticipated base level demand, resulting in situations in which utility companies are forced to either shut down the base demand generation facilities or find a way to dump off unwanted excess power. Accordingly, a need in the art exists for solutions that reduce the cost of providing and managing the supply of power.

Further, the present electrical-power generation system and distribution grid utilizes both renewable and non-renewable power generation sources. Social-awareness of the benefits of and environmental needs for renewable power has been increasing, but present economic conditions and business and cost structures are limiting the growth of the renewable energy market. Further, many types of renewable power generation sources, such as wind power and solar power, produce energy based on environmental conditions independent of demand requirements. Accordingly, a need in the art exists for solutions that increase the rate of growth of such renewable energy market and that will allow energy from renewable power generation sources, as well as conventional non-renewable power generation sources, to be managed in an efficient manner.

### SUMMARY

The above-described problems are addressed and a technical solution is achieved in the art by systems and methods for power management, according to various embodiments of the present invention. In some embodiments of the present invention, an indication is received by a data processing system indicating at least that (a) an electrical storage system is to have power stored therein when a current price of power is below a first predetermined price, (b) the electrical storage system is to have power released therefrom when the current price of power is above a second predetermined price, or (c) both (a) and (b). The data processing system also receives an indication of the current price of power, and instructs storage of power in the electrical storage system when the current price of power is below the first predetermined price, if the indication so indicates, and instructs release of power from the electrical storage system when the current price of power is above the second predetermined price, if the indication so indicates. The first predetermined price and the second predetermined price can be the same or different. When they are different, the second predetermined price is greater than the first predetermined price.

In these and related embodiments, power consumers can generate or save money by storing (e.g., buying) power when the price of power is low, and releasing (e.g., selling) power or using it for personal purposes when the price of power is high. This arrangement provides an incentive for power consumers to have electrical storage systems, which benefits power providers, such as utility companies, by, among other things, giving them an extra source of power when demand is high.

In some embodiments, the current price of power, the first predetermined price, and the second predetermined price are associated with a price of power generated by a renewable power generation source.

In some embodiments, a data processing system receives an indication that a power consumption facility is to receive, at least in part, power generated by a renewable power generation source over power generated by a non-renewable power generation source. In response to the receiving, the data processing system instructs charging of at least a first fee to an account associated with the power consumption facility. The first fee is associated with delivery of the power from the renewable power generation source to the power consumption facility. The first fee is different than a second fee associated with delivery of the power from the non-renewable power generation source to the power consumption facility. In these and related embodiments, power consumers have an ability to choose power generated from one or more particular power generation sources, such as wind power generation sources, or, more particularly, a particular provider of wind power from multiple wind power generation sources.

In this regard, in some embodiments, the plurality of power generation sources includes a plurality of renewable power generation sources and a plurality of non-renewable power generation sources. In this case, the indication received by the data processing system can further indicate that the power consumption facility prefers, at least in part, power from a subset of the plurality of renewable power generation sources over power from others of the plurality of renewable power generation sources and from the non-renewable power generation source.

The plurality of renewable power generation sources can include a plurality of independent and unaffiliated renewable power generation entities. In this regard, the independent and unaffiliated renewable power generation entities can provide a same or different type of renewable power generation. Examples of the same type of renewable power generation include wind-power generation, solar-power generation, or hydro-electric power generation.

In some embodiments, the data processing system also receives an indication that the power consumption facility is to receive power from a particular renewable power generation source only if the first fee is less than a predetermined amount. In these embodiments, a power consumer can exhibit a preference for power from a renewable power source but set a limit as to how much extra he or she is willing to pay for such power. Allowing power consumers to select power from particular sources will impact demand for such particular power sources and, consequently, can impact decisions of utility companies regarding which types of power sources to invest in the future.

Additional features, advantages, objects, embodiments, etc. of the invention will become apparent to those skilled in the art from the following detailed description of the preferred embodiments of the invention and the accompanying drawings.

### BRIEF DESCRIPTION OF THE DRAWINGS

The present invention will be more readily understood from the detailed description of embodiments presented herein considered in conjunction with the attached drawing, of which:

FIG. 1 illustrates a system for managing power, according to embodiments of the present invention.

It is to be understood that the attached drawing is for purposes of illustrating the concepts of the invention and may not be to scale.

### DETAILED DESCRIPTION OF THE PREFERRED EMBODIMENTS

Embodiments of the present invention provide distributed power storage capabilities for power-providers, such as utility companies or independent power producers (e.g., an independent renewable power provider), by placing electrical storage systems at power consumption facilities. For example, customers of a utility company can have an electrical storage system, such as a battery system, placed locally at their places of power consumption, such as homes or businesses. Although local placement is not required, such storage systems provide benefits for the utility company (or other power provider) and their customers. The power provider benefits because it gains storage capacity to store excess power generated during off-peak hours that might normally be wasted, and gains access to extra power during peak hours upon release of the stored power. In the case of utility companies, the extra storage allows them to forego the capital expenditure associated with acquiring or building “peaking plants.” The customers benefit because the electrical storage systems provide a vehicle for generating or saving money by purchasing cheap power at off-peak and either selling it back to the utility company during peak at a higher price or using it for their own purposes. In particular, embodiments of the present invention allow such customers to store (e.g., buy) power when power prices are low, and release (e.g., sell) power back into the electrical grid when power prices are high.

With or without electrical storage systems, some embodiments of the present invention allow power consumers, e.g., customers of a utility company, to purchase power from particular power generation sources. For example, a particular power consumer may prefer power from a renewable power generation source over power from a non-renewable power generation source. In this regard, some of these embodiments of the present invention allow power consumers to select power from preferred power generation sources depending upon current power prices associated with such preferred sources. For instance, a power consumer may desire power generated by wind, but is only willing to pay an extra 10% over current prices for non-renewable power. In this case, some embodiments of the present invention instruct delivery of power generated by wind when such pricing condition is met. Consequently, competition and demand for preferred power generation sources is enhanced and growth of markets for preferred power generation sources is facilitated.

The invention is inclusive of combinations of the embodiments described herein. References to a particular embodiment and the like refer to features that are present in at least one embodiment of the invention. Separate references to an embodiment or particular embodiments or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. Further, it should be noted that, unless otherwise explicitly noted or required by context, the word “or” is used in this disclosure in a non-exclusive sense.

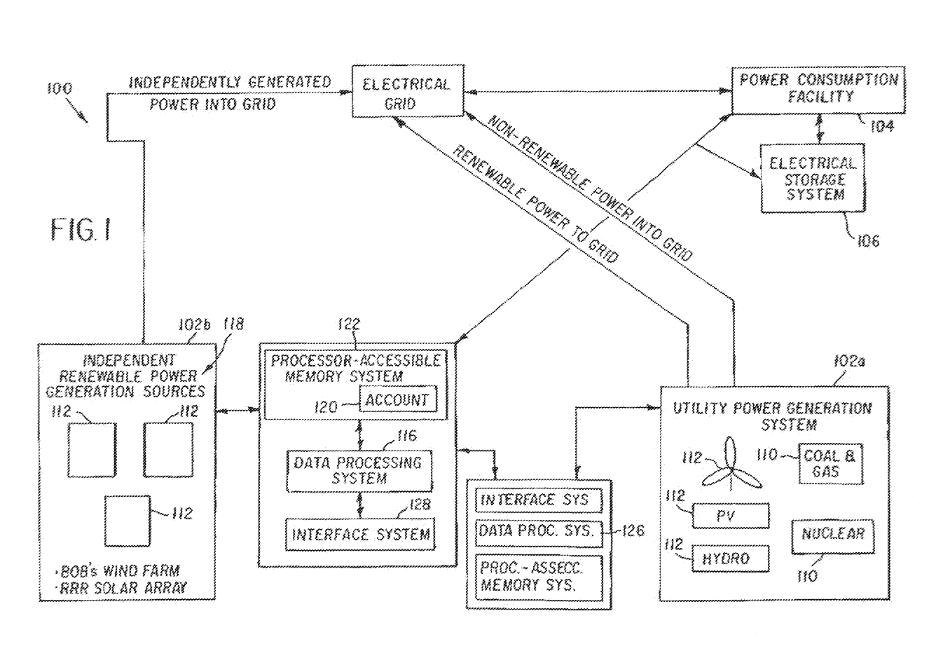

FIG. 1 illustrates a power management system 100, according to various embodiments of the present invention. In FIG. 1, power generation systems 102a, 102b each include a plurality of power generation sources. Power generation sources can include renewable power generation sources 112, non-renewable power generation sources 110, or both. Although two power generation systems 102a, 102b are shown in FIG. 1, one of ordinary skill in the art will appreciate that any number of power generation systems can be present. Further, although FIG. 1 illustrates a plurality of power generation sources 110, 112 in each power generation system 102, any number of power generation sources can be present in a power generation system.

Although not required, FIG. 1 illustrates a first power generation system 102a that is associated with a conventional utility company or other legal entity. As is the case with conventional utility entities, the power generation system 102a, in the example of FIG. 1, provides utility power to an electrical grid 108 from a variety of renewable power generation sources 112 and non-renewable power generation sources 110 using techniques known in the art. Examples of renewable power generation sources 112 include wind power generation sources, hydro-electric power generation sources, solar power generation sources, and photovoltaic power generation sources. Examples of non-renewable power generation sources 110 include coal, gas, and nuclear power generation sources.

FIG. 1 also illustrates an optional power generation system 102b that includes a plurality of independent and unaffiliated renewable power generation companies or other legal entities 118. In this regard, each renewable power generation source 112 in system 102b can belong to or be operated by a power generation entity that is independent and unaffiliated with entities owning or operating other renewable power generation sources 112 in system 102b or even with a utility company owning or operating the power generation system 102a.

Power generated from the independent and unaffiliated renewable power generation sources 112 in system 102b is provided to the electrical grid 108 using techniques known in the art. For example, a first company, “Bob's Wind Farm”, may operate wind generators that supply wind power to the electrical grid 108 independently of a second company, “RRR Solar Array”, which may operate solar panels that supply solar power to the electrical grid 108.

Also connected to the electrical grid 108 is a power consumption facility 104, such as a residential home or a commercial business. The power consumption facility 104 is connected to the electrical power grid via connection 114 and consumes electrical power provided by the power generation systems 102a, 102b. In some embodiments, the power consumption facility 104 includes an electrical storage system 106 that stores power from the electrical grid 108 and releases power to the electrical grid 108, depending upon conditions described in more detail below. The electrical storage system 106 can include one or more batteries, battery systems, or other electrical storage devices or systems known in the art. Although FIG. 1 shows only a single power-consumption-facility-electrical-storage-system pair 104, 106, multiple pairs can be present.

According to some embodiments, the power management system 100 also includes a data processing system 116, a processor-accessible memory system 122, and an interface system 128. The processor-accessible memory system 122 and the interface system 128 are communicatively connected to the data processing system 116. The data processing system 116 can be communicatively connected to data processing systems associated with power consumption facilities 104, a data processing system 126 at a utility company associated with power generation system 102a, and data processing systems associated with power generation system 102b. On the other hand, all of such data processing systems can be considered part of the data processing system 116 in some embodiments. Similarly, although FIG. 1 illustrates the data processing system 116, the processor-accessible memory system 122, and the interface system 128 as stand-alone entities, such systems can be located anywhere in the power management system 100. For example, the data processing system 116, the processor-accessible memory system 122, and the interface system 128 could be located within the electrical storage system 106 in a self-contained unit, at the power consumption facility 104 separately from the electrical storage system 106, or at power generation systems 102a, 102b. Alternatively, the data processing system 116, the processor-accessible memory system 122, and the interface system 128 could be distributed across multiple parts of the power management system 100. For example, different portions of the data processing system 116, the processor-accessible memory system 122, and the interface system 128 could be located in the electrical storage system 106, the power consumption facility 104 separately from the electrical storage system 106, at power generation systems 102a, 102b, or combinations thereof.

The data processing system 116 includes one or more data processing devices that implement the power management methods of the various embodiments of the present invention described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The processor-accessible memory system 122 includes one or more processor-accessible memories configured to store information, including the information needed to execute the methods of the various embodiments of the present invention described herein. The processor-accessible memory system 122 may be a distributed processor-accessible memory system including multiple processor-accessible memories communicatively connected to the data processing system 116 via a plurality of computers or devices. On the other hand, the processor-accessible memory system 122 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 122 is shown separately from the data processing system 116, one of ordinary skill in the art will appreciate that the processor-accessible memory system 122 can be stored completely or partially within the data processing system 116. Further in this regard, although the interface system 128 is shown separately from the data processing system 116, one skilled in the art will appreciate that system can be located completely or partially within the data processing system 116.

The interface system 128 can include a mouse, a keyboard, another computer, or any device or combination of devices from which data is input to the data processing system 116.

The interface system 128 also can include a display device, a processor-accessible memory, or any device or combination of devices to which data is output by the data processing system 110. In this regard, if the interface system 128 includes a processor-accessible memory, such memory can be part of the processor-accessible memory system 122 even though the interface system 128 and the processor-accessible memory system 122 are shown separately in FIG. 1.

A. Use of Electrical Storage System for Buy/Sell Decisions

As previously described, the electrical storage system 106 provides benefits to power providers, such as utility companies or independent power generation entities, and power consumers. The power provider benefits because it gains storage capacity to store excess power generated during off-peak hours that might normally be wasted, and gains access to extra power during peak hours upon release of the stored power. In the case of utility companies, they can forego or reduce the capital expenditures associated with acquiring or building “peaking plants.” The power customers or consumers benefit because the electrical storage systems provide a vehicle for generating or saving money. In particular, embodiments of the present invention allow such customers to store (e.g., buy) power when power prices are low, and either release (e.g., sell) power back into the electrical grid when power prices are high or use the power purchased at a low price for their own purposes at a future time.

In this regard, the data processing system 116 executes a method for managing power, in some embodiments, in which the data processing system 116 receives an indication indicating at least that (a) the electrical storage system 106 is to have power stored therein when a current price of power is below a first predetermined price, or (b) the electrical storage system 106 is to have power released therefrom when the current price of power is above a second predetermined price.

For example, a power consumer associated with power consumption facility 104 can inform the data processing system 116, via software application or other techniques known in the art, of a first predetermined price at which to buy power (e.g., store power in electrical storage system 106), a second predetermined price at which to sell power (e.g., release power from the electrical storage system 106 into the electrical grid 108), or both. The predetermined prices can be actual money values, such as X dollars, or can be a relative amount, such as a percentage of some other price.

The first predetermined price (e.g., the buy price) can be the same or different than the second predetermined price (e.g., the sell price). In cases where they are the same, the power consumer can inform the data processing system 116 of a single price that, below which, power is stored in the electrical storage system 106, and above which, power is released from the electrical storage system 106. In cases where the first predetermined price and the second predetermined price are different, the second predetermined price (e.g., the sell price) is greater than the first predetermined price (e.g., the buy price), and a region of prices exists where neither storage (e.g., buying) of power nor release (e.g., selling) of power occurs.

In addition to receiving the indication regarding the first and second predetermined prices described above, the data processing system 116 receives an indication of the current price of power. This receiving of the indication of the current price of power can occur before or after the receiving of the indication regarding the first and second predetermined prices.

Having access to the current price of power and the first predetermined price, the second predetermined price, or both, the data processing system 116 instructs storage of power in the electrical storage system when the current price of power is below the first predetermined price, if specified, and instructs release of power from the electrical storage system when the current price of power is above the second predetermined price, if specified, or both, if both prices are specified. In this regard, the power consumer associated with the power consumption facility 104 and electrical storage system 106 has an opportunity to generate or save money based on buying power at a low price and, either using or selling power when the price is higher.

The instructing by the data processing system 116 of storage or release of power to or from the electrical storage system 106 can occur by the sending of a message from the data processing system 116 to the electrical storage system 106. In this regard, the electrical storage system 106 can include a data processing system (separate or integrated with system 116) that receives the message and controls the electrical storage system 106 to store power, release power, or retain power, as appropriate. However, one skilled in the art will appreciate that the invention is not limited to any particular technique for controlling the electrical storage system 106 to store, release, or retain power.

In some embodiments, the power consumer associated with power consumption facility 104 and electrical storage system 106 can decide not only when to buy or sell power generally, but can also decide what types of power generation source(s) from which to buy and sell power. For example, the power consumer may decide that only power from a renewable power generation source 112 or a particular subset of the renewable power generation sources 112 should be stored in the electrical storage system 106. In this regard, the power consumer informs the data processing system 106, and the data processing system 106 receives an indication of the selected power generation source(s) using techniques known in the art. Further in this regard, the first predetermined price (if applicable), the second predetermined price (if applicable), and the current price of power received by the data processing system 116 can all pertain to the price of power associated with the selected power generation source(s). In these embodiments, when the current price of power from a selected power generation source is below the first predetermined price, the data processing system 116 instructs storage of power from the selected power generation source in the electrical storage system 106. On the other hand, when the current price of power from the selected power generation source is above the second predetermined price, the data processing system instructs release of power from the electrical storage system 106.

B. Purchase of Power from Particular Power Generation Sources

Regardless of whether power consumption facilities 104 have electrical storage systems 106, some embodiments of the present invention allow power consumers, e.g., customers of a utility company or a third party energy exchange or management system, to purchase power from one or more particular power generation sources. Optionally, the decision to purchase power from the particular power generation sources depends upon whether predetermined pricing criteria are met. Allowing power consumers to select power from particular sources will impact demand for such particular power sources and, consequently, can impact decisions of utility companies regarding which types of power sources to invest in the future.

According to some of these embodiments, the data processing system 116 executes a method for power management in which the data processing system 116 receives an indication that the power consumption facility 104 is to receive, at least in part, power generated by a selected renewable power generation source 112 over power generated by a non-renewable power generation source 110. In response to receiving such an indication, the data processing system 116 instructs charging of at least a first fee to an account 120 associated with the power consumption facility 104. The first fee is associated with delivery of power from the selected renewable power generation source 112 to the power consumption facility 104. The first fee is different than a second fee, which is associated with delivery of power from a non-renewable power generation source 110 to the power consumption facility 104.

For example, a power consumer associated with power consumption facility 104 may decide that it is preferred that power generated by wind be utilized by power consumption facility 104. In this regard, the power consumer can inform the data processing system 116, using techniques known in the art, that the power consumption facility 104 should be powered only by wind power generated by wind power generation sources, i.e., a subset of the renewable power generation sources 112. Assume that power consumption facility 104 uses one-hundred kilowatt hours in a month, and that the average price per kilowatt hour for wind-generated power is $10, the data processing system 116 instructs the charging of $1,000 (100 kilowatt hours times $10) to the account 120 associated with power consumption facility 104. On the other hand, if the average price per kilowatt hour for power generated by non-renewable power generation source is $5, the power consumption facility 104 would have been charged $500 (100 kilowatt hours times $5) if only non-renewable power generation were used by the power consumption facility 104.

Although the above example illustrates a decision by a power consumer to use renewable power for all of the power needs of the power consumption facility 104, this need not be the case. The power consumer could, instead, inform the data processing system 116, using techniques known in the art, of a preference that a certain percentage of the power needs of the power consumption facility 104 be supplied by one or more renewable power generation sources 112.

Further, the power consumer need not only select a particular type of renewable power, e.g., wind, solar, but can select power from one or more particular providers of the particular type of power. For example, the power consumer can request power generated from a company, “Bob's Wind Farm”, i.e., a subset of the renewable power generation sources 112, as opposed to any wind power generation source.

Since renewable power generation sources currently are more expensive than non-renewable power generation sources, some embodiments of the present invention can be utilized to make the decision of whether or not to use renewable power for a power consumption facility 104 depending upon the current price of such renewable power. In this regard, the data processing system 116 can receive an indication that the power consumption facility is to receive power from the selected renewable power generation source(s) only if the corresponding fee (i.e., “first fee”) is less than a predetermined amount. For example, the power consumer can inform the data processing system 116, using techniques known in the art, that power from one or more selected renewable power generation sources is to be delivered to the power consumption facility 104 only if the current price of such power is less than $8 per kilowatt hour. Or alternatively, the power consumer may want to spend a maximum of $200 per month on renewable energy. In this case, renewable power is delivered to the power consumption facility 104 until current monthly usage exceeds the $200 limit. If the current price per kilowatt hour, or current usage fee for a billing period is less than the predetermined amount, the requested renewable power is delivered to the power consumption facility 104, and the data processing system 116 instructs the charging of the associated fee.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

100 Power Management System
102a Power Generation System
102b Power Generation System
104 Power Consumption Facility
106 Electrical Storage System
108 Electrical Grid
110 Non-Renewable Power Generation Source
112 Renewable Power Generation Source
114 Connection
116 Data Processing System
118 Independent and Unaffiliated Renewable Power Generation Entities
120 Account Associated with Power Consumption Facility
122 Processor-Accessible Memory System
126 Data Processing System Associated with Utility Company or other Entity
128 Interface System

What is claimed is:

1. A method implemented at least in part by a data processing system, the method for managing power and comprising:
receiving an indication indicating at least that (a) an electrical storage system is to have power stored therein when a current price of power is below a first predetermined price, or (b) the electrical storage system is to have power released therefrom when the current price of power is above a second predetermined price;
receiving an indication of the current price of power;
instructing storage of power in the electrical storage system when the current price of power is below the first predetermined price, if the indication so indicates; and
instructing release of power from the electrical storage system when the current price of power is above the second predetermined price, if the indication so indicates.

2. The method of claim 1,
wherein the indication indicates at least that (a) an electrical storage system is to have power stored therein when a current price of power is below a first predetermined price, and (b) the electrical storage system is to have power released therefrom when the current price of power is above a second predetermined price, and
wherein the first predetermined price and the second predetermined price are a same price.

3. The method of claim 1,
wherein the indication indicates at least that (a) an electrical storage system is to have power stored therein when a current price of power is below a first predetermined price, and (b) the electrical storage system is to have power released therefrom when the current price of power is above a second predetermined price,
wherein the first predetermined price and the second predetermined price are different prices, and
wherein the second predetermined price is greater than the first predetermined price.

4. The method of claim 1, wherein the electrical storage system is associated with a power consumption facility.

5. The method of claim 1, wherein the current price of power, and the first predetermined price or the second predetermined price are associated with a price of power generated by a renewable power generation source.

6. The method of claim 4, wherein the power consumption facility is a residential home.

7. A power management system comprising:
a data processing system; and
a memory system communicatively connected to the data processing system and storing instructions configured to cause the data processing system to implement a method for power management, wherein the instructions comprise:
instructions for receiving an indication indicating at least that (a) an electrical storage system is to have power stored therein when a current price of power is below a first predetermined price, or (b) the electrical storage system is to have power released therefrom when the current price of power is above a second predetermined price;
instructions for receiving an indication of the current price of power;
instructions for instructing storage of power in the electrical storage system when the current price of power is below the first predetermined price, if the indication so indicates; and
instructions for instructing release of power from the electrical storage system when the current price of power is above the second predetermined price, if the indication so indicates.

8. The system of claim 7,
wherein the indication indicates at least that (a) an electrical storage system is to have power stored therein when a current price of power is below a first predetermined price, and (b) the electrical storage system is to have power released therefrom when the current price of power is above a second predetermined price, and
wherein the first predetermined price and the second predetermined price are a same price.

9. The system of claim 7,
wherein the indication indicates at least that (a) an electrical storage system is to have power stored therein when a current price of power is below a first predetermined price, and (b) the electrical storage system is to have power released therefrom when the current price of power is above a second predetermined price,
wherein the first predetermined price and the second predetermined price are different prices, and
wherein the second predetermined price is greater than the first predetermined price.

10. The system of claim 7, wherein the current price of power, and the first predetermined price or the second predetermined price are associated with a price of power generated by a renewable power generation source.

11. The system of claim 7, further comprising the electrical storage system.

12. The system of claim 11, wherein the electrical storage system, the data processing system, and the memory system are located in a self-contained unit.

13. The system of claim 7, wherein the data processing system and the memory system are located remotely from the electrical storage system.

14. The system of claim 7, wherein the data processing system is communicatively connected to a plurality of electrical storage systems.

15. The system of claim 14, wherein each of the electrical storage systems are associated with a different power consumption facility.

16. The system of claim 7, wherein the instructions for instructing storage comprise instructions for instructing a data processing system associated with a utility company or other entity to deliver power generated by a power generation system to the electrical storage system.

17. The system of claim 16, further comprising the data processing system associated with the utility company or other entity.

18. The system of claim 18, further comprising the power generation system.

19. A method of managing power, the method implemented at least in part by a data processing system and comprising:
receiving an indication that a power consumption facility is to receive, at least in part, power generated by a renewable power generation source over power generated by a non-renewable power generation source; and
instructing, in response to the receiving, charging of at least a first fee to an account associated with the power consumption facility, the first fee associated with delivery of the power from the renewable power generation source to the power consumption facility, and the first fee being different than a second fee associated with delivery of the power from the non-renewable power generation source to the power consumption facility.

20. The method of claim 19, wherein the plurality of power generation sources comprises a plurality of renewable power generation sources and a plurality of non-renewable power generation sources, and wherein the indication further indicates that the power consumption facility prefers, at least in part, power from a subset of the plurality of renewable power generation sources over power from others of the plurality of renewable power generation sources and from the non-renewable power generation source.

21. The method of claim 20, wherein the plurality of renewable power generation sources comprises a plurality of independent and unaffiliated renewable power generation entities.

22. The method of claim 21, wherein the independent and unaffiliated renewable power generation entities provide a same type of renewable power generation.

23. The method of claim 22, wherein the same type of renewable power generation is wind-power generation, solar-power generation, or hydro-electric power generation.

24. The method of claim 19, further comprising:
receiving an indication that the power consumption facility is to receive power from the renewable power generation source only if the first fee is less than a predetermined amount; and
determining that the first fee is less than the predetermined amount.

25. A power management system comprising:
a data processing system; and
a memory system communicatively connected to the data processing system and storing instructions configured to cause the data processing system to implement a method for power management, wherein the instructions comprise:
instructions for receiving an indication that a power consumption facility prefers, at least in part, power generated by a renewable power generation source over power generated by a non-renewable power generation source; and
instructions for instructing, in response to the receiving, charging of at least a first fee to an account associated with the power consumption facility, the first fee associated with delivery of the power from the renewable power generation source to the power consumption facility, and the first fee being different than a second fee associated with delivery of the power from the non-renewable power generation source to the power consumption facility.
